(19) United States
(12) Patent Application Publication
(10) Pub. No.: US 2003/0056418 A1
(43) Pub. Date: Mar. 27, 2003

(54) Recyclable game bird

(76) Inventors: William Eric Mason, Upper Boddington (GB); Trevor Howard Shaw, Daventry (GB)

Correspondence Address: Mr. W. E. Mason, 19 Warwick Road, Upper Boddington, NN11 6DH, GB

(21) Appl. No.: 10/094,893

(22) Filed: Mar. 12, 2002

(30) Foreign Application Priority Data
Sep. 26, 2001 (GB) GB 2360463 A

(51) Int. Cl. A01M 31/06

(52) U.S. Cl. 43/2

(57) ABSTRACT

A recyclable electric bird which simulates a game bird in flight, and, when engaged correctly by shooters falls to earth as the actual bird would, it can then be flown again. The wings are stabilised and locked in place by solenoid operated pins, a two stage timer is preset thus determining flight height and longevity. Inside the body of the bird a ducted fan motor provides the thrust for forward momentum, a solid state gyro and receiver interact to provide attitude information to servos which operates an elevating tail thus giving straight and level flight.

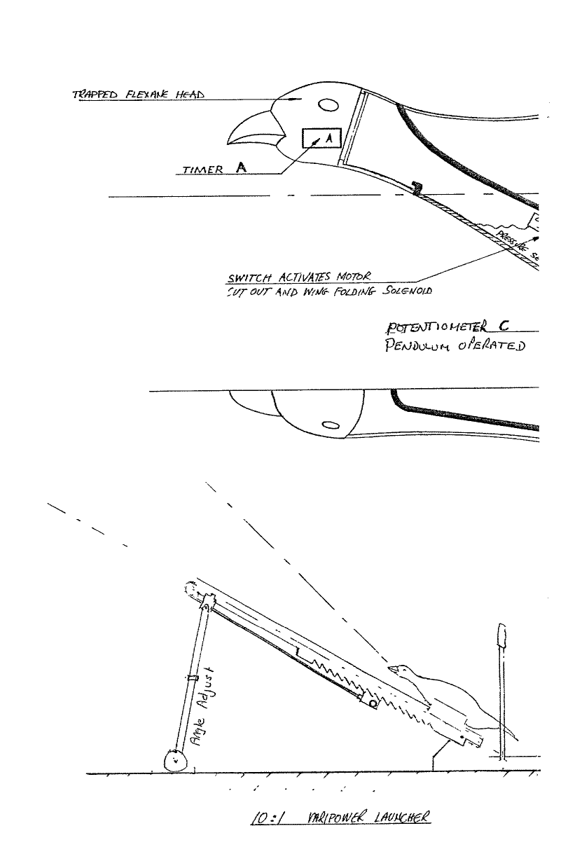

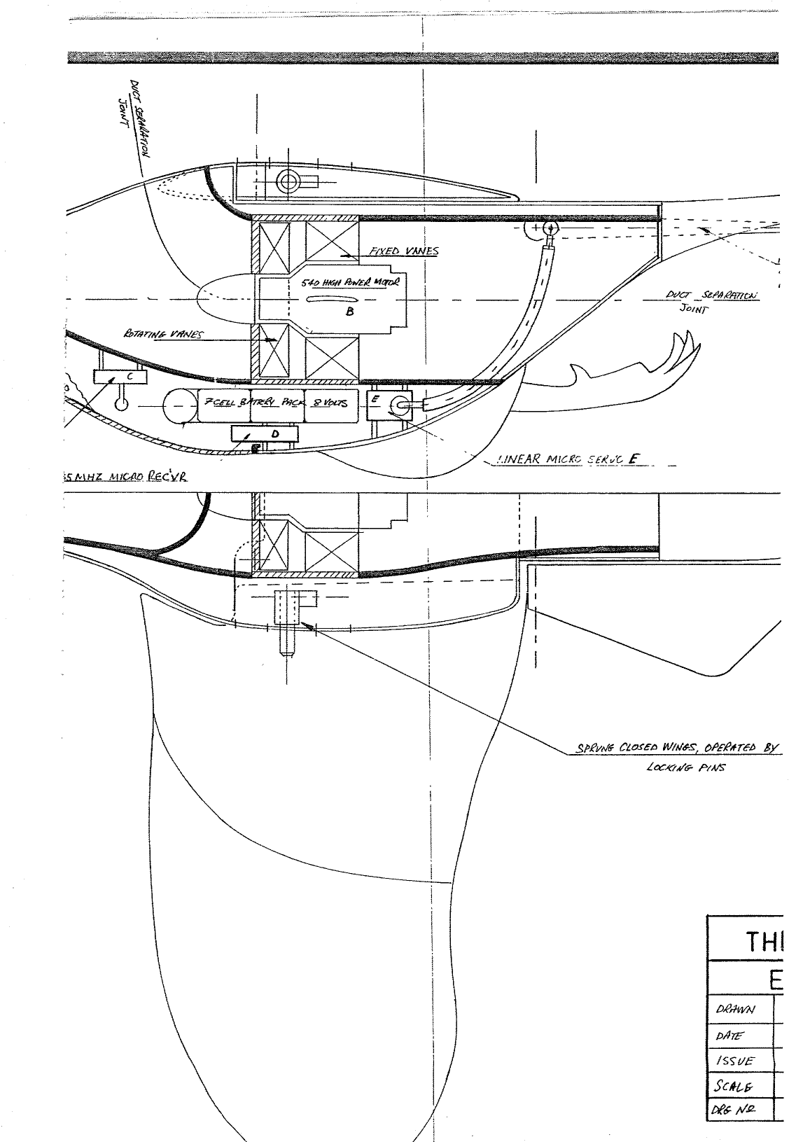

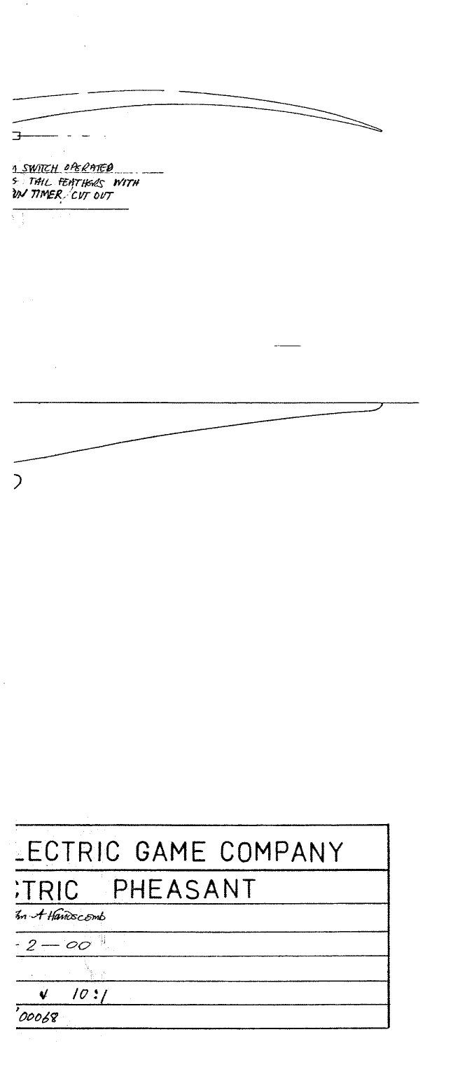

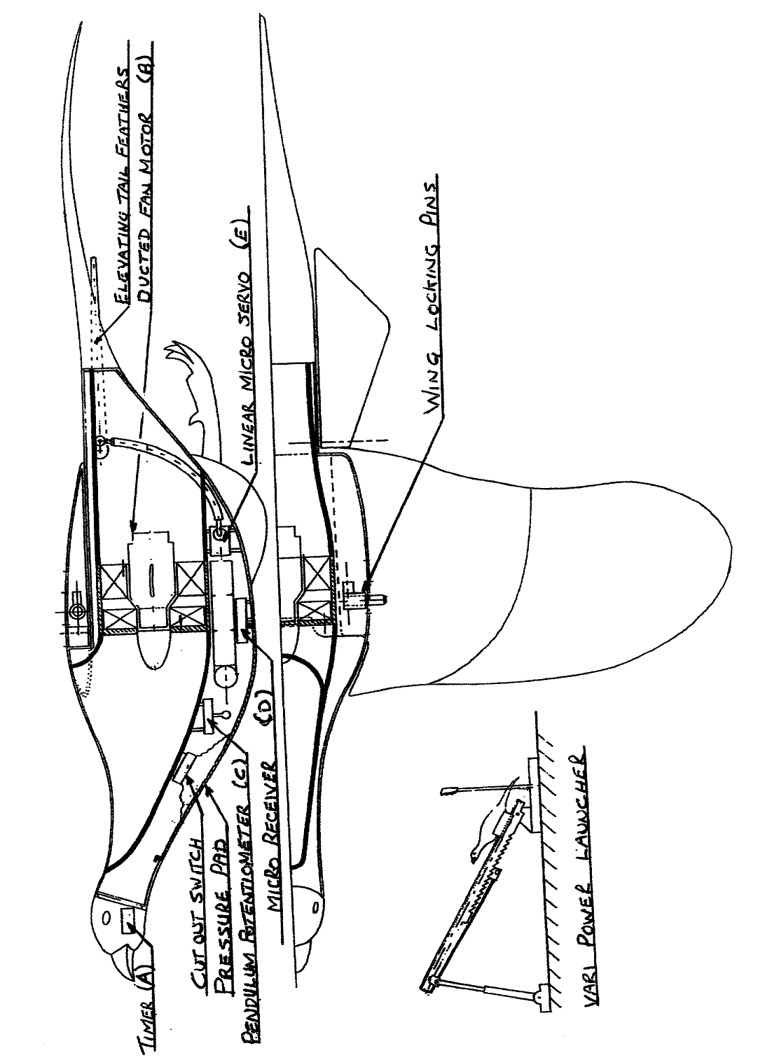

Should the bird, when in flight be hit on a pressure pad, the dc supply provided by an on board battery disconnects from on board equipment, the wing locking pins are withdrawn via springs causing them to clap, the motor shuts down, the gyro and receiver are no longer interactive and the whole thing becomes unstable and falls to earth thus simulating a stricken game bird.

### BACKGROUND

I have been to local shoots as an observer as part of the envisaged project. There is a certain ethos generated by those who attend these meetings, food, drink and then a host of apparently well heeled individuals appear and shoot Pheasants as a sport. The cost of rearing birds with associated nursery, food and minders, employing beaters, keeping land is very expensive and to the Land owner and Shooter can be on off days extremely frustrating.

On more than one occasion beaters beat, shooters stood, dogs sat and not a bird appeared. Here is where our idea comes in, if we could simulate a target which looked like a Pheasant in flight and if hit correctly would behave like a Pheasant and was also recyclable we have a ready made adaptable market, whether stand alone or mix and match with existing shoots. A Landowner can make an instant decision whether to launch recyclable birds or not depending upon the quality of the days shoot. I can also see shoots consisting entirely of electric birds, they are easily transportable, the venue, direction of flight, height etc can be easily altered to suit all sportsmans tastes. The icing on the cake will be dog retrieval; I believe this is possible by the use of specific materials and scent.

It has taken a while to investigate the possibility of achieving a likeness to a Pheasant in flight etc. The Pheasant is the easiest to copy as its flight pattern is straight and relatively low, on take off it appears from behind a hillock or tree line and fly's away from the beaters on a glide path which usually takes them over the shooters at various heights within shotgun range. We can exploit its relatively simple flying style in a model, unlike the snipe or woodcock which zig zag and do all sorts of on the wing patterns, this is not to say at a later date when we gain more experience with electronic control that these types of bird will not be added to the list.

I believe that new legislation will eventually force the demise of Pheasant shoots in Europe; it is also becoming more expensive to rear the birds for sport. People are more aware of the environment than ever before with associated country wildlife, we intend to exploit that market with the ersatz pheasant and the use of degradable shot. The cartridges will be manufactured for Electric Game Company and will be part of the sales package.

### SUMMARY

A short account of the main points of the project as follows:

To design and build a prototype recyclable game bird.

To market the recyclable bird as a business both in the UK and overseas.

To expand the shooting season of Pheasant outside the August 12^{th} to January 31^{st} window which is law in UK.

This invention is intended to complement “Game Bird Shooting”, in particular the initial target will be the Pheasant shooting fraternity.

Landowners and Farmers will generate income from “Shooting Weekends” from the shooting fraternity and “Company Corporate Days”. A whole new B&B business generated.

The anti blood sport lobby will be satisfied.

Environmental issues addressed, recyclable birds & degradable shot.

Future legislation, as current in some European countries addressed, pheasant chicks can be reared but not for shooting.

### DETAILED DESCRIPTION

Please read the Technical Description with the General Arrgt Drawing as reference forwarded:

Bird Body

The main body and wings will be constructed of an impact resistant material such as Kevlar, this ensures a light construction which can withstand the impact of shot (not lead) and a fall to earth, the whole structure is then painted in Pheasant colours. The shotgun cartridges will be manufactured to the specification of the company and will be decorated Green background with the legend Electric Game Company in Black on them, the shot will be a compound of resins which will achieve the range of lead but not the destructive impact on the target they are also fully degradable which contributes greatly to environment protection.

The main components consist of Timer “A”. DC supplies provided by onboard Nickel Cadmium batteries (fast charge). A co-axial 540 ducted fan motor for forward thrust and momentum “B”. A potentiometer (trim pot), which is pendulum operated for stability in flight “C”. A two-channel receiver “D”. Servo motor “E”. Most of these items are available from any good quality model aircraft retailer. Please Note: Other forms of thrust are being considered but are not part of this spec.

Sequence of Events.

The bird is launched from a spring operated ground launcher with the wings locked in place. A two stage timer “A” now becomes operational at the instant of launch via an inertia switch, the setting of the timer stage 1, set to say 3 seconds after launch, would determine the height the target will achieve before the second stage of the timer becomes effective.

When the second timer stage becomes effective:

The DC supply is now switched on, the co-axial motor “B” provides thrust and forward flight. The pendulum operated potentiometer “C” which is set for straight and level flight provides attitude information to the receiver “D” which operates the servo “E” which is attached to elevons via a control link thus ensuring the birds forward flight is straight and level, the attitude can be changed by adjusting the controls for gradual climb or descent depending upon the nature of the shoot terrain, however once set up for that particular shoot any further adjustment will not be necessary.

The guns having been fed and watered will see a game bird approaching which cannot be identified as either recyclable or real. If they hit the bird correctly on the front pressure pad the power supply is cut off, all on board equipment is non functional the pins are withdrawn from the wings and the whole thing becomes unstable and falls to earth, the dogs should retrieve them as normal (I am at this time working on a locator for missing birds). Any bird that is not hit correctly continues over the heads of the guns, the second stage of the timer now times out which shuts down all onboard equipment, the wing pins are withdrawn and the bird falls to earth behind the guns for retrieval.

The bird is recovered, recharged if necessary and flown again.

What we claim as our invention is:

1. A Mechanical/Electrical device which simulates a game bird in flight, the device if traumatised by “shot” will fall to earth.

2. A device as in 1 that is ground launched by a spring assisted launcher, it then achieves a set height and longevity of flight as determined by the operator.

3. A device as in 1 and 2 which is automatically controlled by on board equipment to give straight and level flight at a height and length of time, which is programmed into the onboard equipment.

4. A device as in 1,2 and 3 which if engaged correctly by shooters will cease to be aerodynamic, it will stall and fall to earth.

5. A device as claimed in the previous claims which is manufactured from plastic, wood, foam and other materials giving a finished product which is highly resistant to pellet penetration and induced shock.

6. A Mechanical/Electrical bird is herein described and illustrated with accompanying drawing.
